(19) United States
(12) Patent Application Publication
(10) Pub. No.: US 2002/0116254 A1
(43) Pub. Date: Aug. 22, 2002

(54) Apparatus and method for estimating damage to a building

(76) Inventors: Larry L. Stein, Mosinee, WI (US); Robert J. Brown, Atascadero, CA (US); John F. Bray, Geneva, IL (US)

Correspondence Address: QUARLES & BRADY LLP, 411 E. WISCONSIN AVENUE, SUITE 2040, MILWAUKEE, WI, 53202-4497, US

(21) Appl. No.: 09/785,957

(22) Filed: Feb. 16, 2001

(51) Int. Cl. G06F 17/60

(52) U.S. Cl. 705/11; 705/7

(57) ABSTRACT

An apparatus and method provide a mechanism by which an insurance adjuster or a contractor can accurately inventory damage to a building and calculate the total cost of repairing that damage. A plurality of sheets contain printed indicia representing different building elements that may need to be evaluated in appraising the damage. An input device, such as a barcode reader, is used to scan a selected indicium and provides a signal to a portable computer. The portable computer stores a table of the cost for each of the building elements and the signal is employed to access the cost in the table for the selected building element. That cost is added to the total damage cost and information about the selected building element is stored by the computer. After information for all of the damaged building elements has been entered into the computer, a report is generated detailing the damaged elements, the cost of each one, and the total cost of the damage to the building.

### BACKGROUND OF THE INVENTION

The present invention relates to assessing damage to a building for construction purposes; and more particularly to a computer assisted system for recording the scope of loss and estimating repair or replacement costs.

When a building is damaged, such as by fire, an insurance adjuster inspects the damage and estimates the cost of repair or replacement of the structure. This typically is a very laborious process in which the adjuster inspects the premises to determine the extent of the damage and the specific elements of the building that were either destroyed or damaged. As used herein, “building elements” include structural elements (e.g. studs, floor and ceiling joists, roofing material, windows, and doors) appliances, mechanical systems and components, (e.g. electrical, plumbing and heating/air conditioning systems), decorative features (e.g. molding, trim, wall coverings, and household furnishings) and other elements commonly covered by insurance. At the building site, the adjuster takes meticulous notes of the scope of damage regarding the structural elements and/or contents that were affected. In the case of a damaged wall, for example, the adjuster determines the size of the wood studs and on-center distance between studs, surface material (plaster or drywall), and the wall finish (paint, wallpaper, paneling, etc.). In addition, the cost of any damaged doors or windows in the wall must be included in the repair estimate. This type of assessment of damages, scope of loss, must be repeated for all the structural elements of the building that were damaged. Any damage to plumbing, heating, electrical and other mechanical systems must also be inventoried and repair costs estimated.

The adjuster then uses their handwritten notes on the scope of damage and required repair, determines the costs associated with each damaged item/area, and calculates the total cost of repairing the damage. For example, the adjuster determines the dimensions of a wall that needs to be repaired and types of materials used in that wall, the adjuster calculates the number of replacement studs, amount of drywall, and the type and total surface area that requires finishing. In addition, the labor cost for reconstructing the wall is factored into the estimated repair cost. Similar material and labor cost estimates are performed for all other building elements that were damaged or destroyed. For extensive damage this process may require the adjuster to identify and determine literally hundreds of individual cost items in order to estimate the total cost of the required repairs to the building. Some items, such as a furnace or wall decorations, are subject to depreciation. The adjuster must to determine the depreciated value, based on the useful life expectancy, and condition at the time of the loss.

Then a written report has to be prepared summarizing the scope of loss and the cost of repairing all damaged elements. It is not uncommon for an insurance claim to require over 30 hours of the adjuster's time in scoping the damage, estimating repair costs and preparing the written report.

### SUMMARY OF THE INVENTION

The computer assisted system according to the present invention enables a person to quickly and efficiently record the scope of loss and determine the cost of repair to a building for insurance and construction purposes. This system also can be used to estimate the replacement value of a building or structure for an appraisal or tax assessment.

The estimating system involves a portable computer with a data input device, such as a barcode reader. The portable computer has a electronic storage device that stores a database containing a specific cost for each item of a plurality of building elements, such as wood studs and joists, wall materials, different types of windows and doors, flooring material, plumbing and electrical components.

At the building site the insurance adjuster identifies each damaged building or site element and uses an input device to enter an identification of that element into the portable computer. In the preferred embodiment of the process, the user is provided with paper on which are printed a plurality of barcodes, each related to specific construction element. The insurance adjuster determines the number of units/area to be repaired, then uses an optical reader to scan the appropriate barcodes to indicate both the number of units and the specific element to be repaired. The estimated scope of loss and the associated repair for that specific element is then input into the portable computer.

The portable computer utilizes output from the barcode reader to access the database and obtain the description and cost of the designated building element. The cost may be the entire cost for an item, such as a door, or a unit cost for the building element. For example, the cost per square foot of carpeting which is multiplied by the area of the room to determine the cost of carpeting that room. The cost of the given building element is factored into a total cost for the building which then is stored in the computer's memory. In the preferred process the name of each designated building element and its unit cost also are stored in that memory.

When data about all of the individual building elements have been entered into the portable computer, a report is produced listing the total cost of damage to the building/site. In the preferred system, the report also contains a detailed scope of the damage and the cost for all building elements to be repaired. This system enables an insurance adjuster to accurately determine the extent of damage to a building and/or site, its contents, and calculate the total cost of repair.

### BRIEF DESCRIPTION OF THE DRAWINGS

FIG. 1 is a pictorial illustration of a handheld computer used to estimate the reconstruction cost of a building;

FIG. 2 is a block diagram of the components of the handheld computer;

FIG. 3 depicts sheets of barcodes encoding data for different construction elements that may be entered into the handheld computer to identify features of given building/site;

FIG. 4 is a graphical depiction of the structure of a data conversion table stored in the memory of the handheld computer;

FIG. 5 is a flowchart of the building value estimation process utilizing the handheld computer;

FIG. 6 is a flowchart of a data processing software routine which is executed by the handheld computer; and

FIG. 7 depicts a table of data that is entered by the user and stored within the memory of the handheld computer.

### DETAILED DESCRIPTION OF THE INVENTION

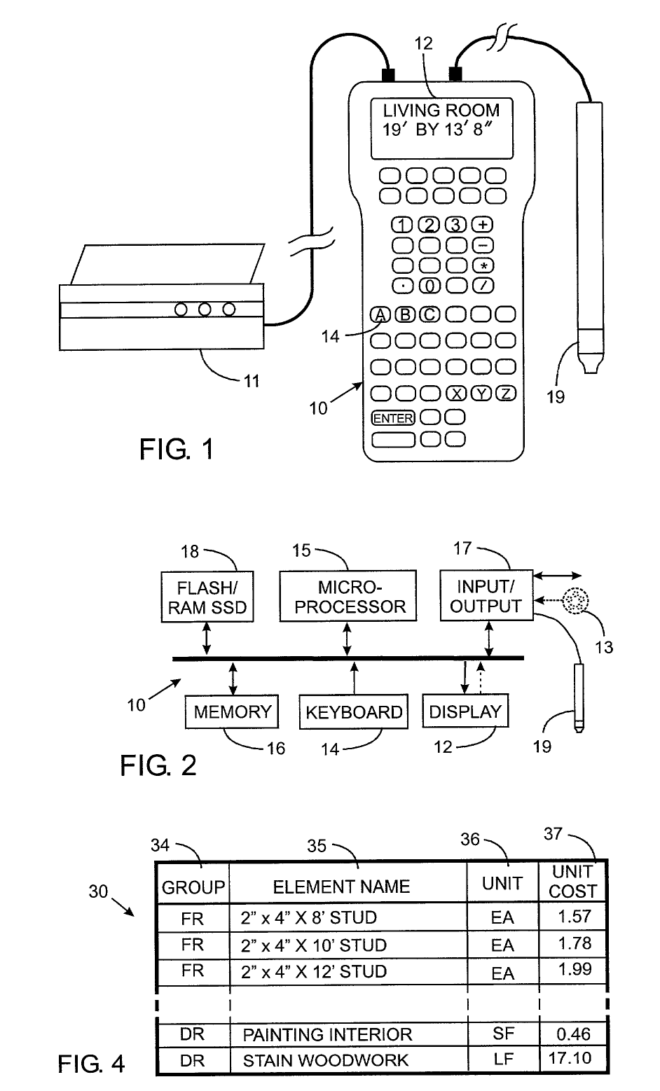

With initial reference to FIGS. 1 and 2, the estimation process utilizes a portable computer 10, such as a WORKABOUT MX handheld model sold, by Psion Incorporated of Concord, Mass., USA. The portable computer 10 features a liquid crystal display screen 12 and an alphanumeric keyboard 14 which also includes keys for punctuation and control functions. The computer 10 incorporates a microprocessor 15, RAM and ROM memory 16, a storage device 18 with a removable medium, and input/output interfaces 17 for connection to devices such as a modem, printer 11 and a desktop personal computer.

Input/output interfaces 17 are provided to attach a barcode reader 19, for example in the form of a wand that the user scans across the barcode. A software program executed by the portable computer 10 converts the output from the barcode reader 16 into the number encoded in the barcode being read.

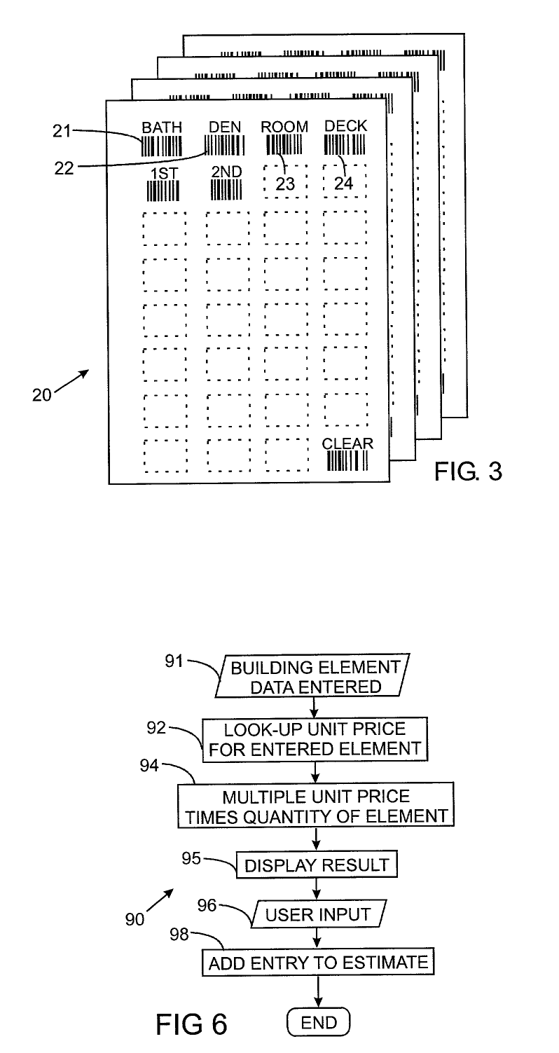

When the insurance adjuster travels to a building/site for which a claim has been submitted, the insurance adjuster carries the portable computer 10 and a series of sheets 20 with a plurality of barcodes 21, 22, 23, 24 printed thereon as shown in FIG. 3. Each barcode 21-24 corresponds to an item of data which can be entered into the portable computer during the estimation process, as will be described. For example, each barcodes correspond to either a structural elements (e.g. studs, joists, windows, doors plumbing fixtures), names of residence rooms, numeric designations for floors of a building (1^{st}, 2^{nd}, 3^{rd}), physical locations (north, south, east, west), and alphanumeric characters. Barcodes also designate various program functions for the portable computer to perform, such as calculate estimated cost, display total cost of damage in current room, or print a report. The barcodes are grouped in relevant categories on the different sheets. For example, one sheet contains the barcodes for different sizes of lumber, while another sheet has the barcodes for plumbing fixtures and other sheets are provided for kitchen cabinets and appliances. These categories are well known to insurance adjusters. Common building elements within each category have been assigned unique barcodes with the name of the element printed above the barcode. For example, barcode 21 in FIG. 3 designates a bath or bathroom. The number which is encoded in the barcode may also be printed on the sheet so that the insurance adjuster will know the numerical designation for commonly occurring building elements and can enter those directly into the keyboard 14 of the portable computer 10 instead of utilizing the barcode reader.

Each barcode encodes a four-digit number. Barcodes that encode numbers between 0000 to 0099 represent specific programmed functions that the computer can perform. For example the number 0000 represents the escape function. Barcodes which begin with 96xx the two most significant digits are used to encode alphanumeric characters for data entry. The two least significant digits are the decimal number of a particular ASCII character. Other series of barcode values are assigned to increments of measure (e.g. 12 feet) and insurance vocabulary terms to speed the entry of frequently used information. When a barcode is scanned, the portable computer determines the type of entry and processes the entry accordingly.

Barcode values beginning at 0500 represent building elements being entered by the insurance adjuster. Information related to these building elements and other items of data assigned barcode numbers in this range are stored in a data conversion table within the memory 16 of the portable computer 10. The structure of the data conversion table 30 is depicted in FIG. 4. The barcode number designates the record of the associated information in the data conversion table.

Each entry in the data conversion table 30 contains a designation of a category or group 34 of building elements to which it belongs, an alphanumeric description 35 of the building element, a unit by which the quantity element is estimated and a unit cost for that element. The quantity of an element may be specified per item as for a piece of lumber, per square foot for elements such as painting work or floor coverings, by the linear foot, or by some other unit of measure in which the goods or services are provided. For example, the first entry in the data conversion table (index zero) is for a piece of dimensional lumber in the framing work category FR that is two inches by four inches by eight feet long and has a unit cost of $1.57. Similarly the next entry is for a two by four that is ten feet long with a unit price of $1.78.

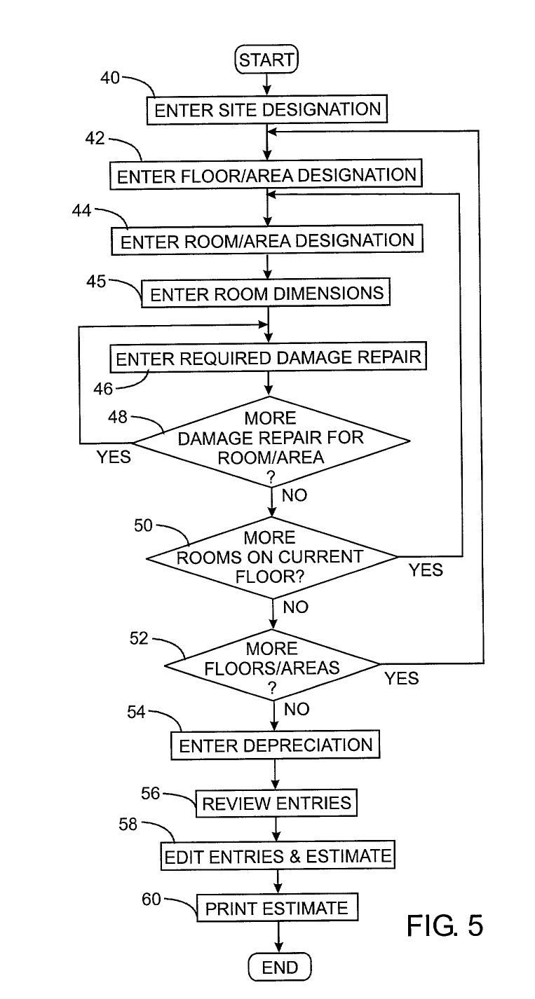

The data regarding a given property may be entered in any order that is convenient. Thus the insurance adjuster can start inside or outside the building and methodically enter the information about each section of the structure that was damaged. FIG. 5 is a flowchart depicting an exemplary estimation process and commences at step 40 with the insurance adjuster entering a designation of the site into the portable computer 10. This may simply be a claim number assigned by the insurance company, the insured's name, and property address. Entering of this designation is accomplished by either by swiping the barcode reader 16 across barcodes for the appropriate alphanumeric characters on the sheets 20, by typing directly into the computer keyboard 14, or by downloading the information via a connection to another computer. If the barcode method is used the microprocessor 15 decodes the signal from the barcode reader 19 to recover the letter or number represented by that signal. Specifically, the microprocessor 15 recognizes a barcoded number with 96 as its two most significant digits as representing an ASCII character and parses the two least significant bits as the numerical value for the ASCII character. This numerical value is entered into a temporary memory area and the characters is displayed on the computer screen 12.

Alternative input mechanisms may be employed. For example, instead of a barcode reader, icons and words designating the different building elements can be displayed on a screen 12 which has a touch sensor allowing the insurance adjuster to touch the icon or word to input information. A variation of the touch screen, such as a personal digital assistant (PDA), enables the insurance adjuster to write characters into the portable computer 10. In another mechanism, a microphone 13 (FIG. 2) is provided to enable the user to say the information to be entered. Speech recognition software converts the audio signal into data characters that are stored in the computer's memory. In addition to the display screen 12, the portable computer 10 may be able to use synthesized speech to communicate information to the user.

The insurance adjuster then begins entering information about each part of the building that has been damaged. At step 42, the keyboard 14 or the barcode reader 19 are employed to input a designation of the floor (e.g. basement, first floor, second floor, etc.) or area (e.g. exterior) that is being evaluated. Next the specific room or area on that floor is designated at step 44. Such a designation may be living room, dining room, kitchen, bathroom, west bedroom, southeast bedroom, etc. and each room is assigned a unique designation. The cost information is stored in the memory of the portable computer 10 on a room-by-room basis for reporting and analysis. The dimensions for the designated room are entered into the portable computer 10 at step 45 either by use of the keyboard 14 or by swiping the barcode reader 16 across barcodes corresponding to the numerical dimensions in foot and inch gradations. The adjuster then selects an item of damage to enter at step 46. In the case of a room, such items may include damage to walls, ceiling, floor, cabinets, counter tops, mechanical fixtures (such as for plumbing, heating and electrical systems), and appliances. The estimation process may also include steps relating to estimating the cost the contents of the building when the insurance policy covers damage to those items.

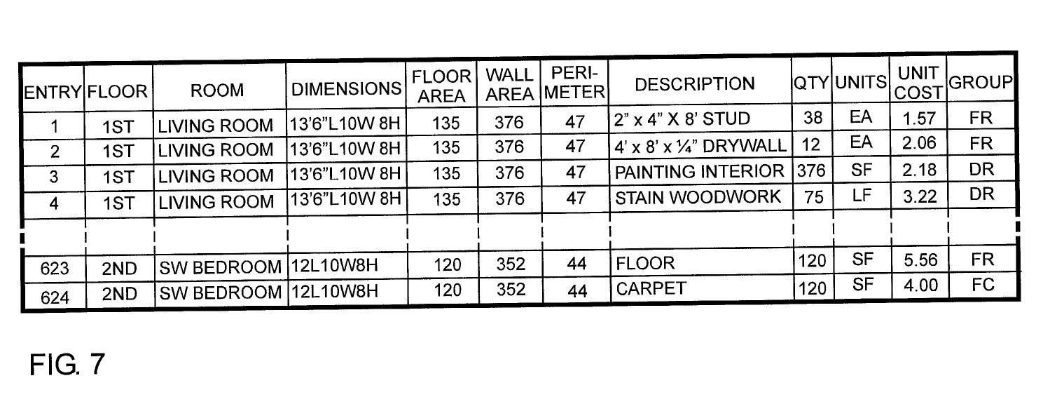

Barcodes are provided for all of the common components of residential and small commercial buildings. For a wall several different barcodes are provided for wall surface materials, such as plaster and drywall, and for wall treatments such as paint, wallpaper, etc. The information about the wall may also include the size and number of studs that have to be replaced. It should be understood that the stud costs for repairing a wall are entered only once and are not entered again when entering the damage to the room on the other side of the wall. However, the cost of damage to the opposing surface of the wall will be entered in that other room. Data also is entered regarding the size and type of doors needing repair, as well as any windows not included in an exterior repair estimate. Similarly a floor may be covered with hardwood, carpeting or vinyl flooring and the ceiling may be drywall, acoustic tile, plaster or other materials. These data are entered by scanning the barcode reader 16 across the appropriate barcodes. The information about each damaged building element is entered into a data table of damaged items that is stored in the computer memory 16. An exemplary damage data table is depicted in FIG. 7. An indication is entered into the portable computer at step 48 whether there are more damaged items to be entered for this room.

It should be understood that at each step of the estimation process the insurance adjuster is prompted to enter the appropriate data items by instructions which appear on the display screen 12.

Once all of the information about the present room has been entered, the insurance adjuster can scan the barcode reader 19 across the Change Room barcode. In that case the program returns to step 44 to await entry of a designation for another room. After the insurance adjuster has finished all damaged areas on one floor, another floor is designated by branching from step 52 to step 42.

Each time that a room has been completed, the microprocessor 15 executes a data processing routine 90 depicted in FIG. 6. As will be described, the data processing routine is executed each time data for a building element is obtained from the data conversion table 30. At steps 91 and 92, the routine takes the newly entered data and looks up the item in the data conversion table 30 stored in the portable computer memory 16. The number encoded by the barcode corresponds to the record number of the selected entry in the data conversion table. This indexing technique results in faster data access than where the barcode encodes data, such as the name of the building element, which is stored randomly in the data conversion table. That latter technique requires the microprocessor 15 to search through the element name data field for the matching entry.

Once the proper record is located, the microprocessor 15 obtains the group designation or work category, element description and unit cost from the accessed entry and stores that information in a data file in memory 16. For example, with respect to estimating the repair for the surface of a damaged roof, the data processing routine 90 utilizes the barcode for the roofing material to find the appropriate unit cost for the repair. Specifically, an asphalt shingled roof will have one unit price per square foot as compared to a roof covered with cedar shingles. In the case of a roof, the unit price then is multiplied at step 94 by the area of the roof which needs to be resurfaced. This damaged area can be calculated, by the portable computer 10, from the roof dimensions entered by the insurance adjuster, or it can be calculated from specific dimensions of the area to be repaired. The result of the calculation at step 94 is a total cost for resurfacing the damaged roof area. Unless the user has selected to review all entries prior to saving the entry in the computer's memory, the entry will be automatically saved and a summary of the entry will be displayed along with the prompt to enter the next item. If the user has selected to review all entries prior to saving each entry in memory, the data processing routine then waits at step 96 for the user to scan either the command instructing either the addition of the roof repair cost to the total estimated claim or clearing the calculated roof repair cost Requiring that the insurance adjuster verify the data entry may be disabled or enabled at any time during the survey by experienced insurance adjusters who are adept at using the portable computer 10.

The portable computer 10 stores not only the new total estimate, but also subtotal by the groups of the building elements or work category. In addition, the group designation, element description, unit cost, quantity and total element cost for each building element is stored in memory 16. That storage is organized by the order in which the data is entered. Additional entries are appended to the estimate data file. Such organization enables meaningful, logically organized reports to be produced based on the sequence of the data entry by the insurance adjuster.

Returning to the process flowchart in FIG. 5, at step 54 the insurance adjuster is afforded an opportunity to select whether depreciation should be considered and enter factors such as percent of useful life remaining for the elements to be depreciated. The insurance adjuster is afforded an opportunity at step 56 to review entries that have been saved in the computer's memory. The entries are displayed sequentially on the screen 12 of the portable computer 10. At this time, the insurance adjuster can edit the entries and correct any errors at step 58. Once the insurance adjuster is satisfied with the accuracy of all entries, regarding the damage claim, a written report can be generated using a printer 11 that is connected to the portable computer 10. Thus allowing the report to be printed directly from that handheld computer at step 60. Alternatively, the portable computer 10 can be connected via a serial communication link (RS-232) to a desktop computer located in the insurance adjuster's office and the building repair data transferred to that other computer for storage or printing. The portable computer 10 may also be connected via a modem or other communication link to a remotely located computer system in order to transmit the information about the claim estimate.

What is claimed is:

1. A system for assessing construction work for a building which incorporates a plurality of building elements, said system comprising:
a medium displaying a plurality of indica, each representing one of the building elements;
a data input device for selecting one of the plurality of indica and producing a signal that indicates the selected one of the plurality of indica; and
a portable computer connected to the data input device and comprising a storage device, a processor and output device, the portable computer responding to the signal from the data input device by storing in the storage device an designation of a given building element corresponding to the selected one of the plurality of indica.

2. The system as recited in claim 1 wherein:
the storage device contains a data table having a plurality of entries with each one corresponding to one of the plurality of building elements and indicating a cost of that one building element;
the processor is connected to the storage device and responding to the signal from the data input device by obtaining the cost of the given building element and utilizing that cost to determine a total cost of construction for the building, and
the output device producing an output signal indicating the total cost of construction.

3. The system as recited in claim 2 wherein each of the plurality of indica encodes a number, and the portable computer uses a number received from the data input device to select a cost contained in the data table.

4. The system as recited in claim 1 wherein the data input device comprises a barcode reader; and the plurality of indica are barcodes.

5. The system as recited in claim 4 wherein each of the barcodes encodes a numerical value and the portable computer uses a numerical value received from the barcode reader to select an entry in the data table.

6. The system as recited in claim 1 wherein the signal from the data input device designates a given command, and the processor responds to the signal by executing the given command.

7. A method for estimating cost of damage to a building which has a plurality of building elements, said method comprising:
(a) providing, at the building, a portable computer having a storage device that stores a data table containing a cost for each of the plurality of building elements, and an input device connected to the portable computer;
(b) identifying a given building element that is damaged;
(c) at the building, utilizing the input device to designate the given building element and producing a signal indicating the given building element;
(d) the portable computer utilizing the signal to access the data table and obtain the cost of the given building element
(e) the portable computer employing the cost of the given building element to calculate a total cost of damage to the building;
(f) repeating steps (b) through (e) for other building elements that were damaged; and
(g) producing an output signal from the output device that indicates the total cost of damage to the building.

8. The method as recited in claim 7 further comprises providing a medium displaying a plurality of indica each of which represents one of the building elements; and wherein utilizing the input device comprises selecting one of the plurality of indica that designates the given building element and the signal indicates that selected indicium.

9. The method as recited in claim 8 wherein the plurality of indica are barcodes; and utilizing a input device comprises utilizing a barcode reader.

10. The method as recited in claim 7 further comprising providing a plurality of barcodes designating commands that are executable by the portable computer; and scanning the barcodes with a barcode reader to provide a signal to the portable computer indicating a command to be executed.

11. The method as recited in claim 7 wherein utilizing a input device comprises selecting an icon on a display screen of the portable computer.

12. The method as recited in claim 7 wherein utilizing a input device comprises speaking into a microphone.

13. The method as recited in claim 12 further comprising the portable computer executing a speech recognition program that converts the signal from the microphone into data for accessing the data table in the storage device.

14. The method as recited in claim 7 further comprising multiplying the cost for the given building element by a quantity of the given building element that were damaged to produce an element cost; and wherein the element cost is utilized to calculate the total cost of damage to the building.

15. The method as recited in claim 7 further comprises storing information regarding given building elements designated by the input device; and wherein the output signal produced from the output device also indicates that information.

16. The method as recited in claim 15 wherein the information regarding the given building elements designated by the input device is organized by areas of the building where the given building elements are located.

17. The method as recited in claim 15 wherein the information regarding the given building elements designated by the input device is organized by rooms of the building where the given building elements are located.

18. The method as recited in claim 7 wherein the information regarding the given building elements designated by the input device is organized categories of building elements.

19. The method as recited in claim 7 further comprising producing cost subtotals for a plurality of categories of building elements.

20. The method as recited in claim 7 wherein providing the portable computer comprises assigning a record number to the cost for each of the plurality of building elements, in which the record number indicates a location of that cost in the data table; and the signal from the input device designates the record number assigned to the given building element.

21. A method for estimating a value for a building comprising a plurality of building elements, said method comprising:
(a) providing, at the building, a portable computer having a storage device that stores a data table containing a value for each of the plurality of building elements, and an input device connected to the portable computer;
(b) at the building utilizing the input device to produce a signal designating a given building element which is present in the building;
(c) the portable computer utilizing the signal to access the data table and obtain the value of the given building element;
(d) employing the value of the given building element to calculate a total value for the building;
(e) repeating steps (b) through (d) for additional building elements; and
(f) producing an output signal from the output device that indicates the total value for the building.

22. The method as recited in claim 21 further comprises providing a medium displaying a plurality of indica each representing one of the plurality of building elements; and wherein utilizing a input device comprises selecting one of the plurality of indica that designates the given building element and the signal indicates that selected indicium.

23. The method as recited in claim 22 wherein the a plurality of indica are barcodes; and utilizing a input device comprises utilizing a barcode reader.

24. The method as recited in claim 21 wherein providing the portable computer comprises assigning a record number to the value for each of the plurality of building elements, in which the record number indicates a location of that value in the data table; and the signal from the input device designates the record number assigned to the given building element.
